(19) United States
(12) Patent Application Publication
(10) Pub. No.: US 2019/0212911 A1
(43) Pub. Date: Jul. 11, 2019

(54) CONTROL INPUT SYSTEM

(71) Applicant: THERMALTAKE TECHNOLOGY CO., LTD., TAIPEI CITY (TW)

(72) Inventor: PEI-HSI LIN, TAIPEI CITY (TW)

(21) Appl. No.: 15/996,598

(22) Filed: Jun. 4, 2018

(30) Foreign Application Priority Data
Jan. 5, 2018 (TW) 107200205

(51) Int. Cl. G06F 3/0488; G06F 3/0484; G06F 3/0483

(52) U.S. Cl. CPC G06F 3/04886; G06F 3/0483; G06F 3/04845

(57) ABSTRACT

A control input system has a control device, a computer and a computer peripheral device. An application is installed in the control device. The computer is connected to the control device and a driver is installed in the computer. The computer peripheral device is connected to the computer and is driven by the driver. The application allows the control device to generate an operation signal according to a touch input or a motion sensing acquired by a user interface of the control device. The driver allows the computer to convert the operation signal into a control signal according to a pre-stored data, and the computer peripheral device receives the control signal to perform an action in response to the control signal.

### CROSS REFERENCE

The present disclosure claims the priority benefit of Taiwan Patent Application Number 107200205, filed Jan. 5, 2018. The disclosure of the prior patent application is incorporated herein by reference.

### TECHNICAL FIELD

The disclosure is related to a control input system, and more particularly to a control input system that uses a touch input or a motion sensing on a user interface of a control device to control a computer peripheral device or a computer to perform an action.

### RELATED ART

Computer peripheral devices include a keyboard, a mouse, a joystick, a fan, and an audio device (such as a headphone, a speaker, and so on). The computer peripheral device is connected to an input/output unit of the computer to receive control signals from the computer or generate output signals to the computer.

For example, a light-emitting keyboard can be an output/input device through a USB connection to a computer, and can be driven by a driver installed on the computer. For example, a light-emitting action of the light-emitting keyboard can be controlled by the user inputting the control signal to the light-emitting keyboard. For another example, after the user performs a specific action on the light-emitting keyboard (e.g. sequentially hitting “W”, “A”, “S”, and “D” keys of the light-emitting keyboard), the light-emitting keyboard generates a group of output signals corresponding to the specific action and the group of output signals is transmitted to the computer via the input/output unit.

There are restrictions on how to use existing computers and existing peripheral devices together. For example, each time when a physical key or a physical button on a keyboard, a mouse, or a joystick is hit or pressed, only a letter, a symbol, or an instruction can be generated. Therefore, it is not possible for the user to generate multiple letters, symbols or an instruction set by just one hit or press. For another example, because physical keys or physical buttons on a keyboard, a mouse, and a joystick are in a fixed position, even when executing certain computer software (such as game software), some physical keys or buttons of the keyboard, mouse, or joystick are useless during the entire game (that is, after hitting or pressing these physical keys or buttons, no game operation instruction will be correspondingly generate). However, the user is not allowed to customize the key or button position (e.g. adjust the key or button position or remove the physical key(s) or button(s)), such that an input operation of a user can be inconvenient in some cases.

### SUMMARY

In order to solve the above problems of the prior art or other problems, one purpose of the present disclosure is to provide a control input system having a control device connected to a computer so as to control the computer or a computer peripheral device through a touch input or a motion sensing on a user interface of the control device.

To achieve the above and other objectives, the present disclosure provides a control input system, comprising a control device, a computer, and at least one computer peripheral device. The control device is installed with an application. The computer is connected to the control device and installed with a driver. The computer peripheral device is connected to the computer and driven by the driver. The application allows the control device to generate an operation signal according to a touch input or a motion sensing acquired by a user interface of the control device. The driver allows the computer to convert the operation signal into at least one control signal according to a pre-stored data. The computer peripheral device receives the control signal to perform an action in response to the control signal.

In an embodiment, the action is an input action, the computer peripheral device performs the input action according to the control signal, and transmits one or more output signals generated in response to the input action to an input/output unit of the compute.

In an embodiment, the driver allows the computer to convert the operation signal into the control signals according to the pre-stored data, and the control signals are sequentially executed.

In an embodiment, the computer has a setting interface for setting the pre-stored data of the driver.

In an embodiment, when the application runs on the control device, the user interface of the control device displays virtual buttons, and coordinate positions of the virtual buttons displayed on the user interface of the control device are adjustable.

In an embodiment, the coordinate positions of the virtual buttons displayed on the user interface of the control device are adjustable by the user's dragging the virtual buttons.

In an embodiment, the number of virtual buttons displayed on the user interface of the control device is less than the number of physical keys of the computer peripheral device.

In an embodiment, the number of the computer peripheral devices is more than one, and the number of virtual buttons displayed on the user interface of the control device is less than the number of physical keys of the computer peripheral device.

In an embodiment, the number of the computer peripheral device is more than one, the driver allows the computer to convert the operation signal into the control signals according to the pre-stored data and send the control signals to different ones of the computer peripheral devices.

In an embodiment, the user interface of the control device has a function selection interface, the function selection interface displays a plurality of virtual buttons, and the virtual buttons are linked to different pages to perform different types of control functions, respectively.

In an embodiment, upon occurrence of a specific event predefined in the application executed by the computer, the computer generates a feedback command to the control device through the driver.

To achieve one of the above and other objectives, the present disclosure provides another one control input system, comprising a control device and a computer. The control device is installed with an application. The computer is connected to the control device and installed with a driver. At least one input device is driven by the driver. The application allows the control device to generate an operation signal according to a touch input or a motion sensing on a user interface of the control device. The driver allows the computer to convert the operation signal into at least one control signal according to a pre-stored data. The input device receives the control signal to perform an action in response to the control signal.

In an embodiment, the action is an input action of the input device, the computer further includes a host device, the host device is connected to the input device, and the host device receives the output signal generated in response to the input action.

In an embodiment, the driver allows the computer to convert the operation signal into the control signals according to the pre-stored data, and the control signals are sequentially executed.

In an embodiment, the host device has a setting interface and the setting interface for setting the pre-stored data of the driver.

In an embodiment, when the application runs on the control device, the user interface of the control device displays a plurality of virtual buttons, and coordinate positions of the virtual buttons displayed on the user interface of the control device are adjustable.

In an embodiment, the coordinate positions of the virtual buttons displayed on the user interface of the control device are adjustable by the user's dragging the virtual buttons.

In an embodiment, the number of virtual buttons displayed on the user interface of the control device is less than the number of physical keys of the computer peripheral device.

In an embodiment, the user interface of the control device has a function selection interface, the function selection interface displays a plurality of virtual buttons, and the virtual buttons are linked to different pages to perform different types of control functions, respectively.

In an embodiment, upon occurrence of a specific event predefined in the application executed by the host device, the host device generates a feedback command to the control device through the driver.

To sum up, the control input system of the present disclosure controls the computer or the computer peripheral device to perform an action in response to a touch input or a motion sensing acquired by a user interface of the control device.

### BRIEF DESCRIPTION OF THE DRAWINGS

FIG. 1 is a system block diagram of a control input system according to an embodiment of the present disclosure;

FIG. 2 is a schematic diagram of an operation interface of an application running on a control device of the control input system according to an embodiment of the present disclosure;

FIG. 3 is a schematic sequence diagram of a communication between components in a control input system according to the embodiment of FIG. 2;

FIG. 4 is another schematic diagram of an operation interface of an application running on the control device of the control input system according to an embodiment of the present disclosure;

FIG. 5 is a schematic sequence diagram of a communication between components in a control input system according to the embodiment of FIG. 4;

FIG. 6 is a schematic diagram that a coordinate position of a touch area displayed on the user interface of the control device of the control input system can be adjusted according to an embodiment of the present disclosure;

FIG. 7 is a schematic diagram of another operation interface of an application running on the control device of the control input system according to an embodiment of the present disclosure;

FIG. 8 is a schematic sequence diagram of a communication between components in a control input system according to the embodiment of FIG. 7;

FIG. 9 is a schematic diagram of a computer of a control input system according to an embodiment of the present disclosure;

FIG. 10 is a schematic diagram of a functional selection interface of an application running on a control device of a control input system according to an embodiment of the present disclosure;

FIG. 11 is a system block diagram of a control input system according to an embodiment of the present disclosure;

FIG. 12 is a schematic sequence diagram of a communication between components in a control input system according to the embodiment of the present disclosure; and

FIG. 13 is another schematic sequence diagram of a communication between components in a control input system according to the embodiment of the present disclosure.

### DETAILED DESCRIPTION

In order to fully understand the purpose, characteristics, and efficacy of the present disclosure, a detailed explanation of the present disclosure is given by the following specific examples and in conjunction with the accompanying drawings.

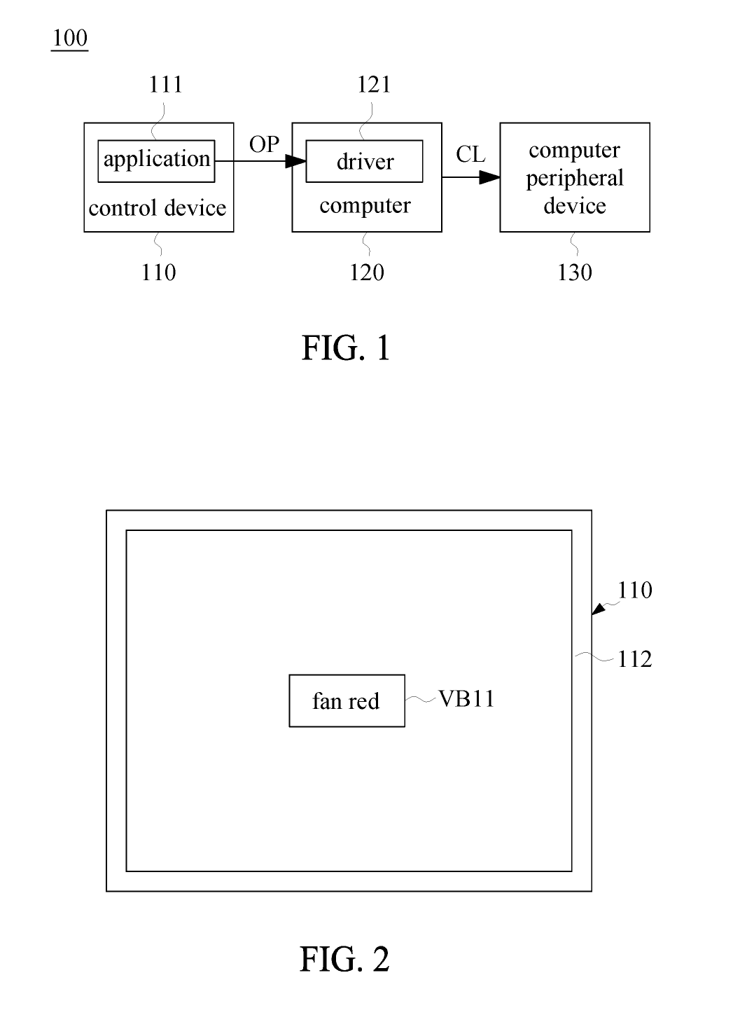

Referring to FIG. 1, FIG. 1 is a system block diagram of a control input system according to an embodiment of the present disclosure. The control input system 100 includes a control device 110, a computer 120, and at least one computer peripheral device 130. The control device 110 is installed with an application 111. The computer 120 is connected to the control device 110 and is installed with a driver 121. The computer peripheral device 130 is connected to the computer 120 and is driven by the driver 121.

The application 111 runs on the control device 110. The application 111 allows the control device 110 to generate an operation signal OP according to a touch input or a motion sensing acquired by a user interface of the control device 110. The driver 121 runs on the computer 120. The driver 121 allows the computer 120 to convert the operation signal OP into the control signal CL according to a pre-stored data. The computer peripheral device 130 receives the control signal CL to perform an action in response to the control signal.

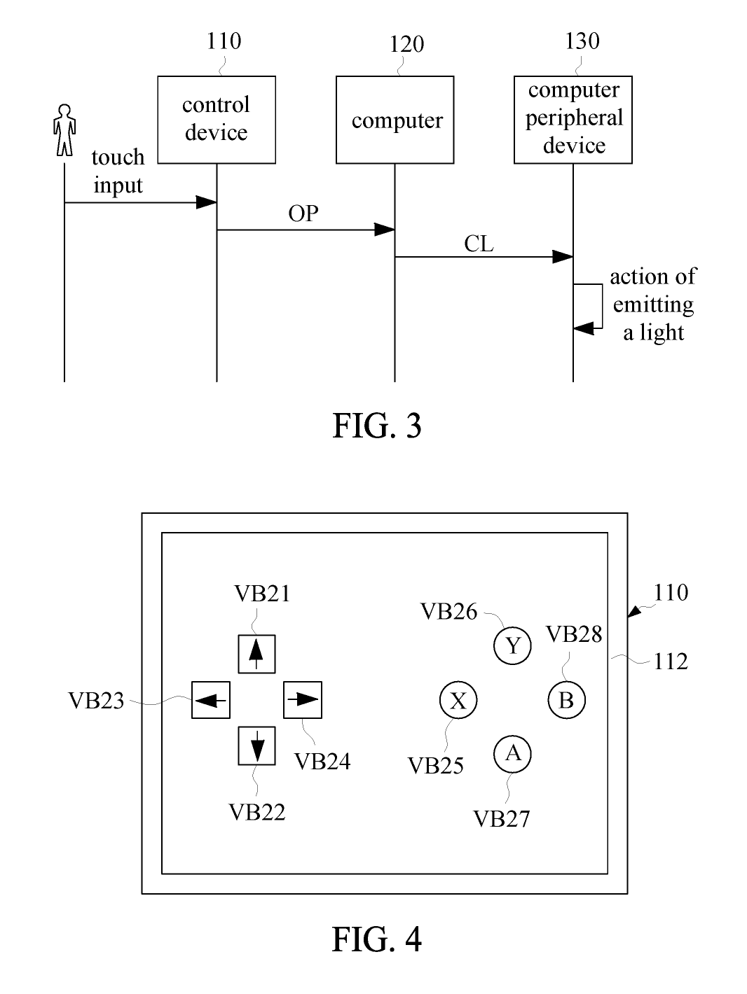

Referring to FIGS. 2 and 3, FIG. 2 is a schematic diagram of an operation interface of an application running on a control device of the control input system according to an embodiment of the present disclosure and FIG. 3 is a schematic sequence diagram of a communication between components in a control input system according to the embodiment of FIG. 2.

A portion of the touch area of the screen of the user interface 112 of the control device 110 has a virtual button VB11 displaying “fan red”. When the user presses the virtual button VB11, the application 111 allows the control device 120 to generate an operation signal OP according to the touch input (i.e. the pressing action) of the user interface 112 of the control device 110. The driver 121 allows the computer 120 to convert the operation signal OP into a control signal CL according to the pre-stored data. The computer peripheral device 130 (fan) receives the control signal CL to perform an action (emitting red light).

In the embodiment of FIGS. 2 and 3, the control device 110 is a mobile phone or a tablet, the computer 120 is a desktop computer, and the computer peripheral device 130 is a fan. The fan is installed inside or outside the enclosure of the computer 120. However, the present disclosure is not limited thereto.

For example, the control device 110 can be a control device other than a mobile phone or a tablet that has the application installed therein. The computer 120 can be a notebook computer or other driver-executable computer device. The computer peripheral device 130 can be a keyboard, a mouse, a joystick, or an audio device (e.g. a headphone or a speaker). In addition, the computer 120 and the computer peripheral device 130 can be implemented as a plurality of independent devices, or as the same device. For example, when the computer 120 is a notebook computer and the computer peripheral device 130 includes a keyboard and a touchpad, the keyboard and the touchpad can be two separate devices and wired/wirelessly connected to the notebook computer. Therefore, a total of three independent devices are used to implement the computer 120 and the computer peripheral device 130. Alternatively, the keyboard and the touchpad can be combined with the notebook computer to implement as the same device.

For example, the user interface 112 of the screen of the control device 110 can display a plurality of virtual buttons. For example, a plurality of virtual buttons can display “keyboard red”, “keyboard yellow”, “keyboard green”, etc., respectively. When the user presses one of the virtual buttons, the light-emitting keyboard emits light of a specific color by the communication sequence between components as shown in FIG. 3.

For example, the number of the computer peripheral devices 130 can be more than one. For example, the computer peripheral device 130 can include a light-emitting keyboard, a fan, and an audio device. When the user presses one of the virtual buttons, the light-emitting keyboard and the fan each emit a specific color of light and the audio device plays a specific sound.

The number of the virtual buttons (the number of the recognizable voice is set to one for exemplary purposes, but is not necessarily limited thereto), the positions of the virtual buttons, and the result after pressing the virtual buttons are pre-stored in the driver 121 by data. Therefore, when the user presses one of the virtual buttons, the driver 121 can generate a control signal CL to the computer peripheral device 130 in time. The pre-stored data in the driver 121 (e.g. the number of the virtual buttons, the position of the virtual buttons, and the result after pressing the virtual buttons) may be set to be fixed and unmodifiable, or may be set to be freely adjustable or defined by a user. The following embodiments will be described in more detail.

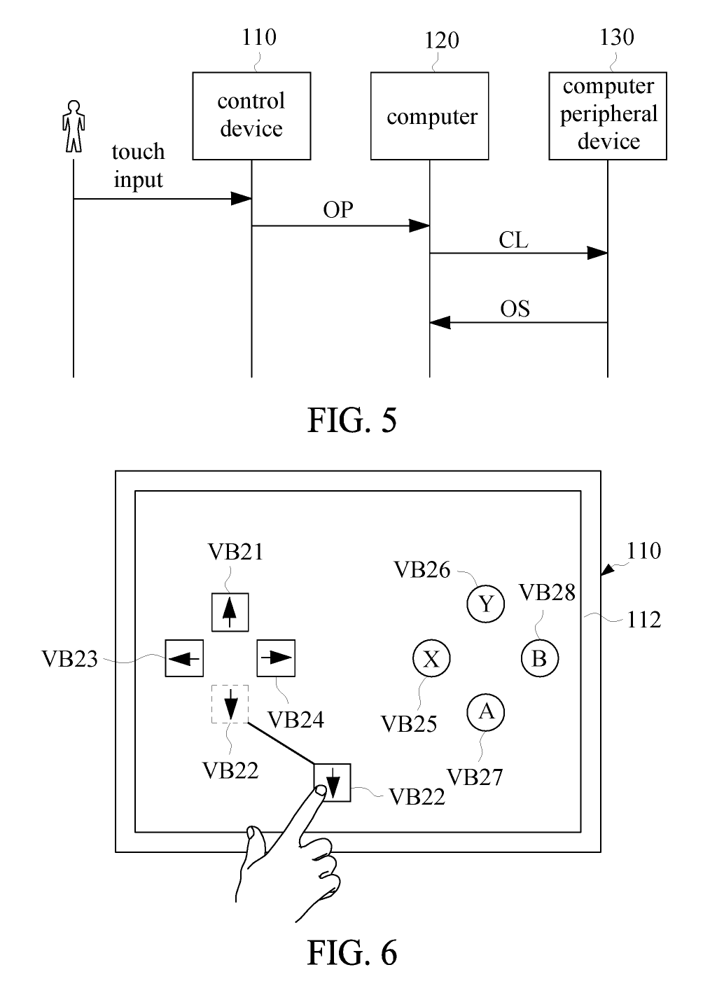

Referring to FIGS. 4 to 6, FIG. 4 is another schematic diagram of an operation interface of an application running on the control device in the control input system according to an embodiment of the present disclosure, FIG. 5 is a schematic sequence diagram of a communication between components in a control input system according to the embodiment of FIG. 4, and FIG. 6 is a schematic diagram that a coordinate position of a touch area displayed on the user interface of the control device of the control input system can be adjusted of according to an embodiment of the present disclosure.

In the embodiment of FIG. 3, the user interface on the screen of the control device 110 has eight virtual buttons V21-V28, which are “↑”, “↓”, “←”, “→”, “X”, “Y”, “A”, and “B”. When the user presses one of the eight virtual buttons V21-V28, the application 111 allows the control device 110 generates an operation signal OP according to the touch input (that is, the press action) on the user interface 112 of the control device 110. The driver 121 allows the computer 120 to convert the operation signal OP into the control signal CL according to the pre-stored data. The computer peripheral device 130 (joystick) receives the control signal CL to perform an action (e.g. generate a corresponding one of the output signals in the present embodiment). An output signal OS generated in response to the touch input action is transmitted to the input/output unit of the computer 120.

In this embodiment, the number of the virtual buttons is designed to be exactly the same as the number of physical keys of the computer peripheral device 130 (joystick). Therefore, the control device 110 can replace the computer peripheral device 130 (joystick), that is, the user can directly input the voice to the control device 110 without having to input through the computer peripheral device 130 (joystick).

The position of each virtual button displayed on the user interface 112 can be adjustable. For example, as shown in FIG. 6, one of the virtual buttons VB21 at the coordinate position of the user interface 112 of the control device 110 is adjusted by dragging. In this embodiment, the virtual buttons with adjustable positions are used to replace the physical buttons of the computer peripheral device 130 (joystick) where the positions of the buttons cannot be adjusted. Therefore, the present embodiment has the advantages of high usage flexibility and convenience for a user operation.

In the embodiment of FIGS. 4 to 6, the control device 110 is a mobile phone or a tablet, the computer 120 is a desktop computer, and the computer peripheral device 130 is a joystick. The number of the adjustable virtual buttons showed on the user interface of the screen is eight. However, the present disclosure is not limited thereto.

For example, the control device 110 can be a control device other than a mobile phone or a tablet that can install the application. The computer 120 can be a notebook computer or other driver-executable computer device. The computer peripheral device 130 can include a keyboard, a mouse, a fan, or an audio device (e.g. a headphone or a speaker). In addition, the computer 120 and the computer peripheral device 130 can be implemented as a plurality of independent devices, or as the same device. For example, when the computer 120 is a notebook computer and the computer peripheral device 130 includes a keyboard and a touchpad, the keyboard and the touchpad can be two separate devices and wired/wirelessly connected to the notebook computer. Therefore, a total of three independent devices are used to implement the computer 120 and the computer peripheral device 130. Alternatively, the keyboard and the touchpad can be combined with the notebook computer to implement as the same device.

For example, the number of the virtual buttons of the control device 110 can be less than the number of the physical keys of the computer peripheral device 130. For example, if a computer software (such as a game software) is executed on the computer 120, except for the four physical keys “↑”, “↓”, “←”, and “→” on the keyboard, other physical keys are useless (that is, the hitting of other physical keys does not correspond to any game operation instruction), the control device 110 can only display the voice input four virtual buttons to replace the four physical keys such as “W”, “A”, “S” and “D” on the keyboard.

For example, when the number of computer peripheral devices is more than one, the number of the virtual buttons displayed on the user interface 112 110 can be more than the number of the physical keys of the one or more computer peripheral devices 130. For example, the user interface 112 can display eight virtual buttons, wherein four of them respectively replace four physical keys “W”, “A”, “S”, and “D” on the keyboard, and the other four of them respectively replace a left mouse button, a middle mouse button (sliding scroller), a right mouse button, and a pointer movement function of the mouse. In this example, the number of the virtual buttons of the control device 110 (that is, eight) is greater than the number of the physical keys of the mouse (that is, three).

For example, the coordinate positions of the virtual buttons VB21-VB28 displayed on the user interface 112 of the control device 110 can be adjusted through means other than dragging. For example, the coordinate positions of the virtual buttons VB21-VB28 recorded in the pre-stored data in the driver 121 can be directly modified by the key input of the keyboard. However, means other than dragging may be user-unfriendly.

Similarly, the number of the virtual buttons (that is, eight), the positions of the virtual buttons, and the result after pressing the virtual buttons are pre-stored in the driver 121 by data. Therefore, when the user presses one of the virtual buttons, the driver 121 can generate a control signal CL to the computer peripheral device 130 in time. The pre-stored data in the driver 121 (e.g. the number of the virtual buttons, the position of the virtual buttons, and the result after pressing the virtual buttons) may be set to be fixed and unmodifiable, or may be set to be freely adjustable or defined by a user. The following embodiments will be described in more detail.

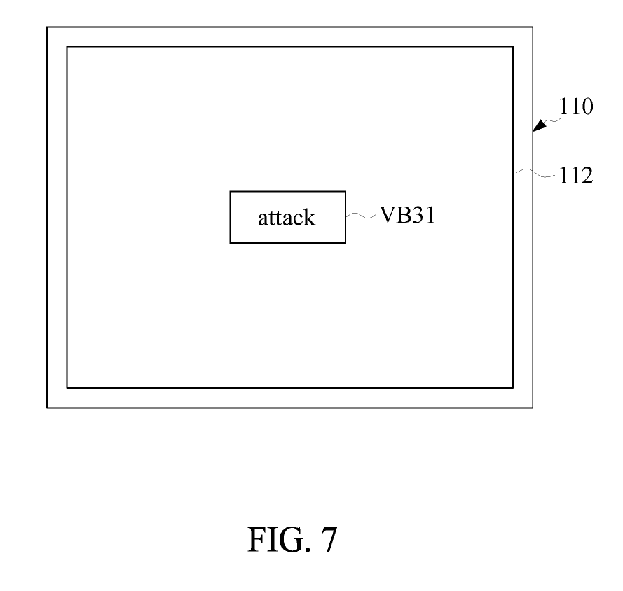

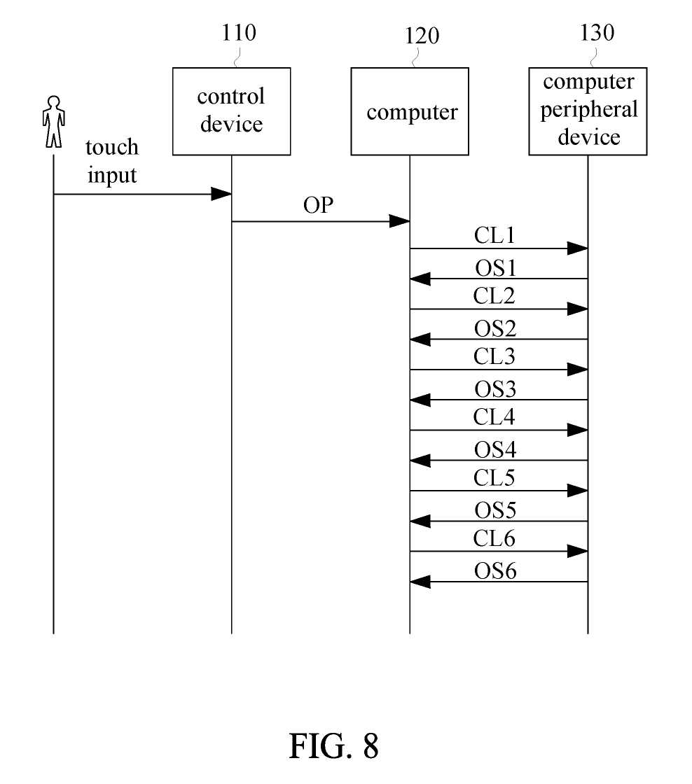

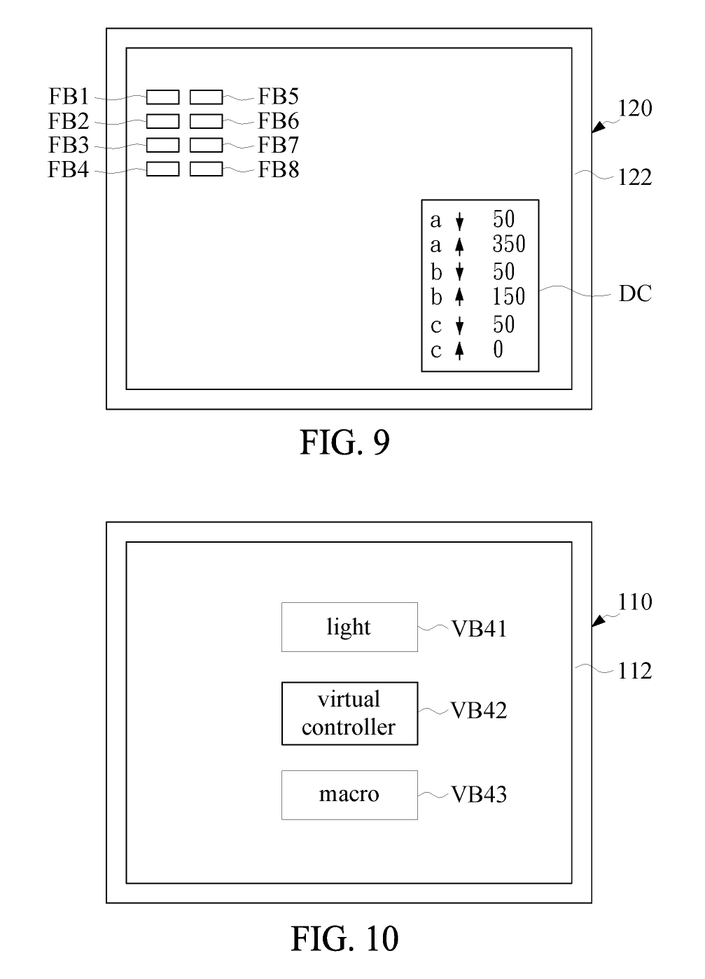

Referring to FIGS. 7 to 9, FIG. 7 is a schematic diagram of another operation interface of an application running on the control device of the control input system according to an embodiment of the present disclosure, FIG. 8 is a schematic sequence diagram of a communication between components in a control input system according to the embodiment of FIG. 7, and FIG. 9 is a schematic diagram of a computer of a control input system according to an embodiment of the present disclosure.

A portion of the touch area of the screen of the user interface 112 of the control device 110 has a virtual button VB31 displaying “attack”. When the user presses the virtual button VB31, the application 111 allows the control device 120 to generate an operation signal OP according to the touch input (i.e. the pressing action). The driver 121 allows the computer 120 to convert the operation signal OP into control signals CL1-CL6 according to the pre-stored data. The computer peripheral device 130 (joystick) receives the control signals CL1-CL6 to perform an action (generating a set of output signals). The set of output signals OS1 to OS6 generated in response to the input action, and the output signals OS1 to OS6 are respectively transmitted to the input/output unit of the computer 120. However, the present disclosure is not limited thereto. For example, the number of output signals can be more or less than six. For example, the control signals CL1-CL6 can be synchronously transmitted to the computer peripheral device 130 or the control signals CL1-CL6 can be combined for generating a control signal.

In the embodiment, the number of the virtual buttons and the result generated after pressing the virtual buttons can be freely adjustable or defined by the user. The pre-stored data setting interface 122 of the driver 121 of the computer 120 is as shown in FIG. 9. An explanatory column DC is provided on the right side of the drawing in FIG. 9. Each description column DC can record one or a set of actions corresponding to one of the virtual buttons. The left side of the drawing of FIG. 9 has a plurality of function buttons FB1 to FB8. The function buttons FB1 to FB8 can be used to realize a storage, a clearing, a copying, an output, an input from another description column of virtual button(s), an increase or decrease of the number of virtual buttons, a modifying of the display name of the virtual buttons, a setting of delay time, and other functions.

The virtual button “attack” of this embodiment is a set of actions for simulating the computer peripheral device 130 (joystick). With reference to a description column DC, the set of actions can be decomposed into six instructions. The first instruction is to press physical keys “a” and “↓” simultaneously and delay for 50 milliseconds. The second instruction is to press physical keys “a” and “↑” simultaneously and delay for 350 milliseconds. The third instruction is to simultaneously press physical buttons “b” and “↓” and delay for 50 milliseconds. The fourth instruction is to press physical keys “b” and “↑” simultaneously and delay for 150 milliseconds. The fifth instruction is to press physical keys “c” and “↓” simultaneously and delay for 50 milliseconds. The sixth instruction is to press physical keys “c” and “↑” simultaneously and has no delay times. The first to sixth instructions can be executed sequentially.

In this embodiment, a set of actions can be generated in response to the control device 110 through a press of the virtual buttons from a user. Compared to the case where the user manually presses the computer peripheral device and only one action can be generated for each press and the duration of the press (i.e. the delay time) may not be accurate, this embodiment can easily meet more complex and more precise operation requirements.

In the embodiment of FIGS. 7 to 9, the control device 110 is a mobile phone or a tablet, the computer 120 is a desktop computer, and the computer peripheral device 130 is a joystick. The user interface 112 of the screen of the control device 110 displays a virtual button VB31. However, the present disclosure is not limited thereto.

For example, the control device 110 can be a control device other than a mobile phone or a tablet that can install the application. The computer 120 can be a notebook computer or other driver-executable computer device. The computer peripheral device 130 can include a keyboard, a mouse, a fan, or an audio device (e.g. a headphone or a speaker). In addition, the computer 120 and the computer peripheral device 130 can be implemented as a plurality of independent devices, or as the same device. For example, when the computer 120 is a notebook computer and the computer peripheral device 130 includes a keyboard and a touchpad, the keyboard and the touchpad can be two separate devices and wired/wirelessly connected to the notebook computer. Therefore, a total of three independent devices are used to implement the computer 120 and the computer peripheral device 130. Alternatively, the keyboard and the touchpad can be combined with the notebook computer to implement as the same device.

For example, the user interface 112 of the screen of the control device 110 can display a plurality of virtual buttons. For example, multiple virtual buttons can display “RPG-attack”, “RPG-defense”, and the like, respectively. The generated set of output signals varies from virtual button to virtual button. When the user presses one of the virtual buttons, the pressed virtual button generates a set of output signals according to the communication sequence of the components as shown in FIG. 8.

For example, the number of virtual buttons displayed on the user interface 112 can be designed to be the same as or different from the number of physical keys of the computer peripheral device 130. The number of computer peripheral devices 130 can be more than two. The position of each virtual button displayed on the user interface 112 can be adjustable or fixed. The coordinate position of the virtual key VB31 on the user interface 112 of the control device 110 can be adjusted by means other than dragging.

Referring to FIG. 10, FIG. 10 is a schematic diagram of a functional selection interface of an application running on a control device of a control input system according to an embodiment of the present disclosure.

The application 111 of the control device 110 can have a function selection interface. The function selection interface has virtual buttons VB41-VB43 to be correspondingly linked to different function selections, respectively. For example, the virtual button VB41 whose button name is “light” is correspondingly linked to the operation interface of FIG. 2. The virtual button VB42 whose button name is “virtual controller” is correspondingly linked to the operation interface of FIG. 4. The virtual button VB43 whose button name is “macro” is correspondingly linked to the operation interface of FIG. 7. When the user presses one of the virtual buttons VB41-VB43, the user interface switches to a corresponding one of the operation interfaces to perform the light control function, the virtual controller function (each hitting or pressing corresponding to an action) and the macro set function (each hitting or pressing corresponding to a set of action).

In the embodiment of FIG. 10, the three virtual buttons VB41-VB43 of the function selection interface are used to implement different functions, respectively. However, the present disclosure is not limited thereto. For example, the function selection interface can have fewer or more virtual buttons. The virtual buttons of the function selection interface can be linked to other possible embodiments of the present disclosure to implement various control over actions of one or more computer peripheral devices.

In addition, the control input system of the present disclosure can have a reminding function. Specifically, when computer software (e.g. a game software) is executed on the computer 120, the computer 120 can generate a feedback instruction if a specific event (e.g. a game character dies or a car is crashed) predefined in the computer software occurs. The feedback instructions can be transmitted back to the control device 110 via the driver 121. Upon receiving the feedback instruction, the control device 110 can alert the user of the occurrence of the specific event by generating a shock or by other means.

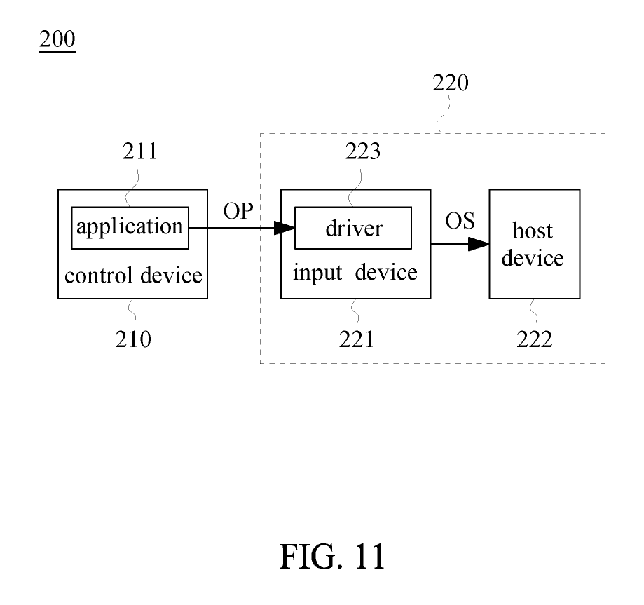

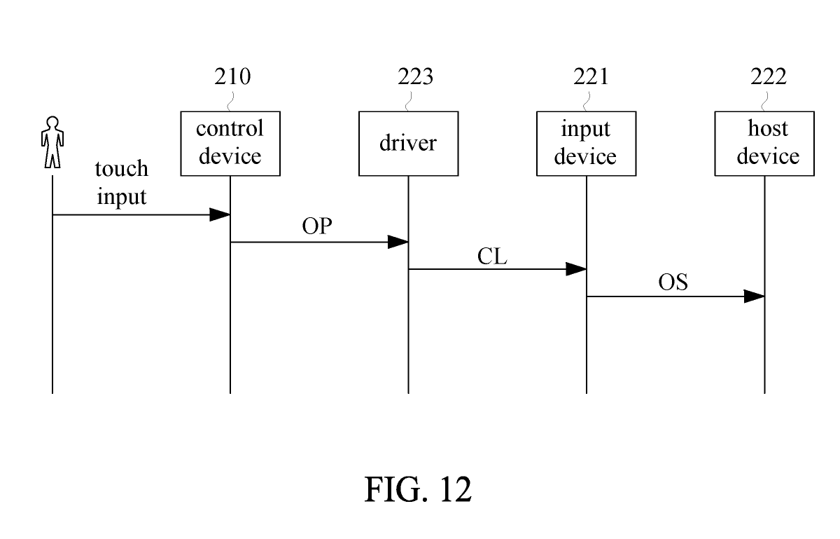

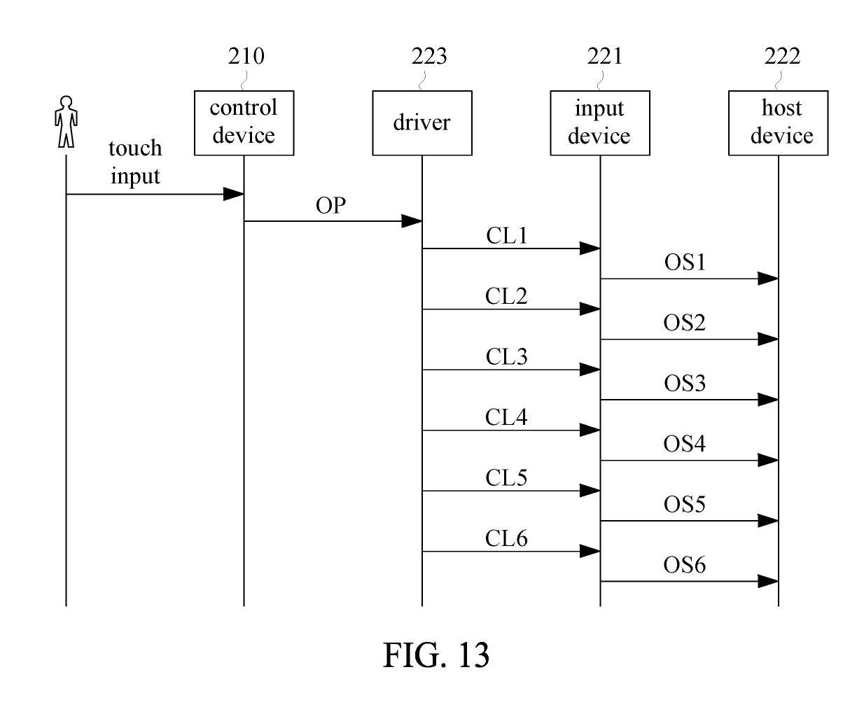

Referring to FIGS. 11 to 13, FIG. 11 is a system block diagram of a control input system according to an embodiment of the present disclosure, FIG. 12 is a schematic sequence diagram of a communication between components in a control input system according to the embodiment of the present disclosure, and FIG. 13 is another schematic sequence diagram of a communication between components in a control input system according to the embodiment of the present disclosure.

A control input system 200 includes a control device 210 and a computer 220. The control device 210 is installed with an application 211. The computer 220 includes an input device 221, a host device 222, and a driver 223. The input device 221 is installed with a driver 223 and is driven by the driver 223.

The application 211 runs on the control device 210. The application 211 allows the control device 210 to generate an operation signal OP according to a touch input or a motion sensing acquired by the user interface of the control device 210. The driver 223 runs on the computer 220. The driver 223 allows the computer 220 to convert the operation signal OP into a control signal CL according to the pre-stored data. The input device 221 receives the control signal CL to perform an action. The host device 222 receives an output signal OS generated in response to an input operation of the input device 221.

The main difference between the control input system 200 and the control input system 100 is that the driver 223 is directly mounted in the input device 221. The host device 222 is able to not have the driver 223 mounted thereon. Therefore, by comparing FIG. 5 and FIG. 12, and comparing FIG. 8 and FIG. 13, it can be found that a communication between components of the control input system 200 and a communication between components of the control input system 100 are slightly different.

For example, the control device 210 can be a mobile phone, a tablet or any other control device that can install the application. The input device 221 can include a keyboard, a mouse, a joystick, and the like. The computer 120 can be a desktop computer, a notebook computer or other computer device. The input device 221 and the host device 222 can be connected via a wired/wireless connection.

The components, the detailed components, or the signals of the control input system 200 have roughly the same ways and functions as the components, the detailed components or the signals of the control input system 100 if they have the same component name. Further, possible variations of the control input system 200 are also roughly the same as the aforementioned possible variations of the control input system 100. Therefore, a detailed description of the control input system 200 is not presented here.

Although the embodiments of FIG. 1 to FIG. 13 described above all use a touch input on the user interface of the control device 110 as an example, the way of input of the present disclosure is not limited to the touch input. For example, when the control device 110 has a gravity sensor, the control input system can be designed to generate operation signals using motion sensing. That is, the control input system can be designed to control the computer peripheral device(s) to perform actions by using motion sensing.

For example, when the user inclines the control device 110 at an angle or holds the control device 110 to perform a specific action, the gravity sensor in the control device 110 can generate an operation signal OP according to a gravity sensing result. The role of the operation signal OP generated in accordance with the gravity sensing result in the system can be similar to that of the operation signal OP generated in accordance with the touch input determination result in the system. That is, the operation signal OP generated according to the gravity sensing result can also have functions as “correspondingly generating multiple control signals”, “correspondingly generating multiple output signals”, “the above correspondence can be set in a setting interface”, etc.

To sum up, the control input system of the present disclosure controls the computer or the computer peripheral device to perform an action through a touch input or a motion sensing acquired by a user interface of a control device.

The present disclosure has been disclosed in the preferred embodiments, but it should be understood by those of ordinary skill in the art to which this disclosure pertains that these embodiments are only for the purpose of depicting the present disclosure and should not be construed as limiting the present disclosure. It should be noted that any changes and substitutions equivalent to those of the embodiments should be set within the scope of this work. Therefore, the scope of protection of the present disclosure shall be subject to the definition of the scope of application for the patent.

What is claimed is:

1. A control input system, comprising:
a control device installed with an application;
a computer connected to the control device and installed with a driver; and
at least one computer peripheral device connected to the computer and driven by the driver;
wherein the application allows the control device to generate an operation signal according to a touch input or a motion sensing acquired by a user interface of the control device, the driver allows the computer to convert the operation signal into at least one control signal according to a pre-stored data, and the computer peripheral device receives the control signal to perform an action in response to the control signal.

2. The control input system according to claim 1, wherein the action is an input action, the computer peripheral device performs the input action according to the control signal, and transmits one or more output signals generated in response to the input action to an input/output unit of the computer.

3. The control input system according to claim 2, wherein the driver allow the computer to convert the operation signal into the control signals according to the pre-stored data, and the control signals are sequentially executed.

4. The control input system according to claim 3, wherein the computer has a setting interface for setting the pre-stored data of the driver.

5. The control input system according to claim 1, wherein when the application runs on the control device, the user interface of the control device displays a plurality of virtual buttons, and coordinate positions of the virtual buttons displayed on the user interface of the control device are adjustable.

6. The control input system according to claim 5, wherein the coordinate positions of the virtual buttons displayed on the user interface of the control device are adjustable by the user's dragging the virtual buttons.

7. The control input system according to claim 1, wherein the number of virtual buttons displayed on the user interface of the control device is less than the number of physical keys of the computer peripheral device.

8. The control input system according to claim 1, wherein the number of the computer peripheral devices is more than one, and the number of virtual buttons displayed on the user interface of the control device is less than the number of physical keys of the computer peripheral device.

9. The control input system according to claim 1, wherein the number of the computer peripheral device is more than one, the driver allows the computer to convert the operation signal into the control signals according to the pre-stored data and send control signals to different ones of the computer peripheral devices.

10. The control input system according to claim 1, wherein the user interface of the control device has a function selection interface, the function selection interface displays a plurality of virtual buttons, and the virtual buttons are linked to different pages to perform different types of control functions, respectively.

11. The control input system according to claim 1, wherein, upon occurrence of a specific event predefined in the application executed by the computer, the computer generates a feedback command to the control device through the driver.

12. A control input system, comprising:
a control device installed with an application; and
a computer connected to the control device, wherein the computer is installed with a driver and at least one input device driven by the driver;
wherein the application allows the control device to generate an operation signal according to a touch input or a motion sensing acquired by a user interface of the control device, the driver allows the computer to convert the operation signal into at least one control signal according to a pre-stored data, and the input device receives the control signal to perform an action in response to the control signal.

13. The control input system according to claim 12, wherein the action is an input action of the input device, the computer further includes a host device, the host device is connected to the input device, and the host device receives the output signal generated in response to the input action of the input device.

14. The control input system according to claim 13, wherein the driver allows the computer to convert the operation signal into the control signals according to the pre-stored data, and the control signals are sequentially executed.

15. The control input system according to claim 14, wherein the host device has a setting interface for setting the pre-stored data of the driver.

16. The control input system according to claim 12, wherein when the application runs on the control device, the user interface of the control device displays a plurality of virtual buttons, and coordinate positions of the virtual buttons displayed on the user interface of the control device are adjustable.

17. The control input system according to claim 16, wherein the coordinate positions of the virtual buttons displayed on the user interface of the control device are adjustable by the user's dragging the virtual buttons.

18. The control input system according to claim 12, wherein the number of virtual buttons displayed on the user interface of the control device is less than the number of physical keys of the computer peripheral device.

19. The control input system according to claim 12, wherein the user interface of the control device has a function selection interface, the function selection interface displays a plurality of virtual buttons, and the virtual buttons are linked to different pages to perform different types of control functions, respectively.

20. The control input system according to claim 13, wherein, upon occurrence of a specific event predefined in the application executed by the host device, the host device generates a feedback command to the control device through the driver.
